(19) United States
(12) Patent Application Publication
(10) Pub. No.: US 2013/0330454 A1
(43) Pub. Date: Dec. 12, 2013

(54) Acoustic Cavitation of Distilled Spirits and Other Beverages

(71) Applicant: Naresh Mahamuni, Nevada City, CA (US)

(72) Inventor: Naresh Mahamuni, Nevada City, CA (US)

(73) Assignee: IMPULSE DEVICES INC., Grass Valley, CA (US)

(21) Appl. No.: 13/490,847

(22) Filed: Jun. 7, 2012

(51) Int. Cl. C12G 3/08

(52) U.S. Cl. 426/238; 99/323.1

(57) ABSTRACT

A system and method for treating an alcoholic beverage product such as a distilled spirit are described. A process including acoustic (e.g., ultrasonic) processing and including acoustic cavitation and/or hydrodynamic cavitation are applied to the beverage product in a controlled fashion so as to achieve a desired transformation thereon.

### TECHNICAL FIELD

This disclosure relates to treatment of distilled spirits and other beverages to enhance the taste or user experience therewith. Specifically, this disclosure teaches the use of cavitation technology to treat consumable drinks such as distilled alcoholic beverage products.

### BACKGROUND

Distilled spirits and beverages are a major consumer product and form the basis of a substantial industry. The primary advantages of one such beverage over others are aesthetic and qualitative, comprising taste, smell, color, and other characteristics of the beverage, in addition to economic attributes of a given beverage (e.g., branding, advertising, cultural trends, price, etc.). To gain market share and revenue, beverage makers place a great emphasis on the aesthetic qualities of their products, most importantly on the taste of their products. Therefore, it is useful for beverage makers to have and use any technological process or device commercially at their disposal to improve the taste, quality and consumer appreciation of their products.

### SUMMARY

Aspects of this disclosure are directed to a system for processing an alcoholic beverage product, comprising a fluid handling circuit that allows movement of said product through said system; an acoustic treatment chamber comprising a fluid holding chamber that holds said product while it undergoes acoustic processing; least one acoustic driver coupled to said acoustic treatment chamber that delivers acoustic energy to said acoustic treatment chamber and said product; and gas control device that controls an amount of gas in said product.

Other aspects are directed to a method for treating an alcoholic beverage product, comprising introducing a liquid alcoholic beverage product into a processing apparatus; applying acoustic energy to said liquid product in an acoustic treatment chamber including causing acoustic cavitation therein; passing said liquid product through a gas control apparatus; controlling an extent of said steps above until said liquid product reaches a desired processing level.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates an exemplary process for treating distilled liquids and other beverages in a cavitation apparatus and fluid handling circuit;

FIG. 2 illustrates an exemplary system for processing liquid distilled beverages;

FIG. 3 illustrates exemplary steps of a method for treating distilled liquids and other beverages in a cavitation apparatus and fluid handling circuit; and

FIG. 4 illustrates an exemplary configuration of an acoustic cavitation chamber and transducers.

### DETAILED DESCRIPTION

The present invention is directed to a method and apparatus for treating drinks. These include drinkable products, and especially those containing alcohol such as distilled spirits, liquors, wines, and similar beverages. Aspects of the invention address the treatment of such beverages with acoustic energy, for example ultrasonic sound waves, and more specifically in some cases those which cause cavitation within the beverage fluid medium.

As is known to those skilled in the art, cavitation can be caused by dropping local regions of a fluid below its saturation pressure for a given temperature, thereby causing a vapor void or gas bubble to be generated at that local region in the fluid. Cavitation can be caused by application of acoustic vibrations of certain frequency and amplitude in liquids. Since the acoustic waves are cyclic pressure waves, it is possible to pull a cavitation void or group of voids (bubble cloud) in a region of a liquid sample subjected to the acoustic waves during the negative pressure phase of such acoustic waves. Constant waveform (CW) or pulsed acoustic signals can be imparted to the contents of a chamber or resonator filled with a liquid sample, causing cavitation therein.

In the present context, acoustic energy and cavitation events are caused in an alcoholic beverage substance residing in an acoustic system having a resonance chamber, reactor, or reservoir. The acoustic chamber is filled with an alcoholic beverage that is to be subjected to cavitation. Ultrasonic sound waves of given energy/amplitude, frequency content, duration are controllably applied to the system. This is usually done by driving one or more acoustic transducers with controllable electrical input signals, typically derived from a computer-based signal generator whose output(s) are passed through one or more signal amplifiers to drive the transducers.

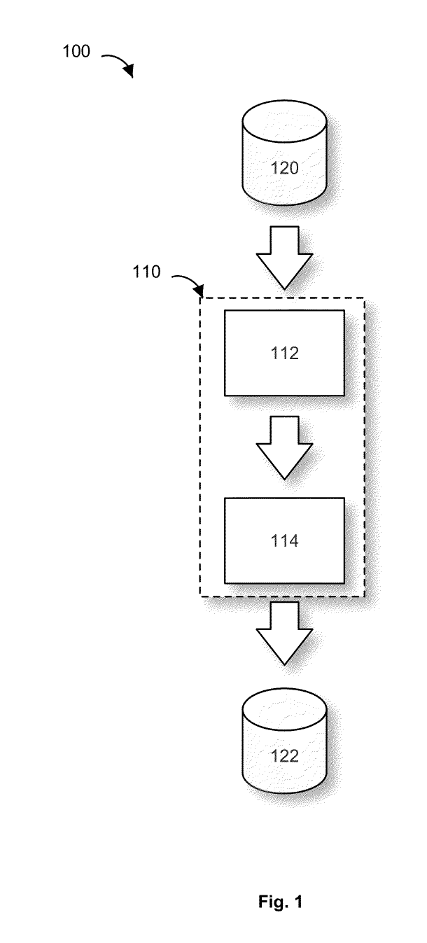

FIG. 1 illustrates process 100 for treating alcoholic beverages using inter alia ultrasonic cavitation energy. In this simplified example, an untreated alcoholic beverage 120 is introduced into a treatment system 110. The treatment system 110 comprises at least an ultrasonic (e.g., including acoustic cavitation) stage 112 and a micro oxygenation stage 114. The above stages of the process 100 act favorably on the ingredients of beverage 120 and the result is a treated beverage 122 having improved and preferred characteristics, e.g., flavor, smell, color, or other attributes. As will be explained below in exemplary illustrations of the process 100 and treatment system 110, the action of the stages of the present process convert a less desirable beverage substance to a more desirable beverage substance.

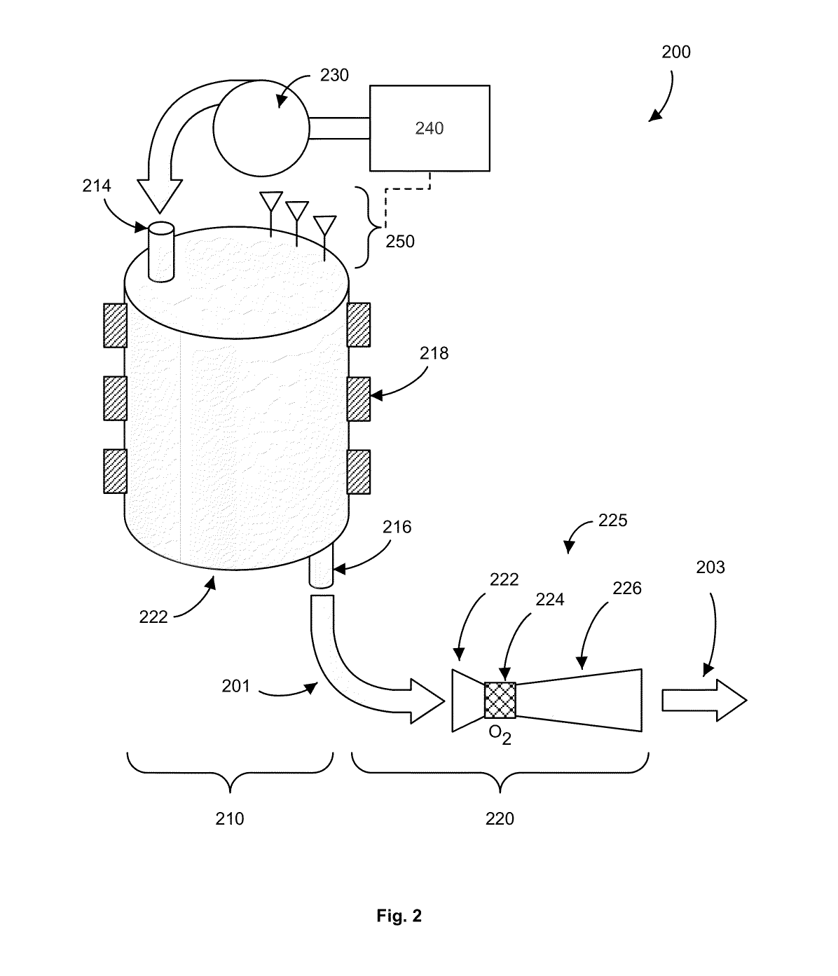

FIG. 2 illustrates an exemplary arrangement of components in a treatment system 200 according to one or more embodiments of the present system. As mentioned before, the present system may include a plurality of processing stages. For example, a first acoustic (e.g., ultrasonic) treatment stage 210, a second (e.g., aeration or oxygenation) stage 220, thermal stages, chemical processing stages, and so on.

In the present example, a pump 230 or other means of delivering untreated liquid alcoholic (e.g., distilled spirit) beverage is provided. The untreated substance is introduced by way of an inlet port 214 into an acoustic processing chamber 222, which may be an acoustic cavitation chamber or reactor. The acoustic processing chamber 222 may include a holding tank made of a shaped solid sheet material such as a metal material in the form of a reservoir or drum or container. The holding tank is coupled to at least one, and preferably a plurality of, acoustic transducers 218 that provide acoustic (e.g., ultrasonic) energy to the walls of the acoustic processing chamber 222 so as to sonicate the contents thereof. In some embodiments, the acoustic drivers 218 deliver energy (according to their driving signals) at a frequency and amplitude so as to cause cavitation in one or more regions of the bulk fluid undergoing treatment in chamber 222.

In some embodiments, the chamber 222 may be pressure controlled. That is, the pressure within chamber 222 may be set to a higher or lower pressure than the external ambient (e.g., atmospheric) pressure. In a specific instance, the pressure within chamber 222 is elevated to a pressure greater than ambient pressure so as to increase the intensity and effects of acoustic cavitation within chamber 222 and thereby enhance the effectiveness of the acoustic processing stage 210 of system 200. In an illustrative example, the walls of the chamber 222 may be made of a material and thickness and construction to withstand an absolute static pressure inside the chamber 222 being at least twice that of the pressure outside the chamber.

In some embodiments, the chamber 222 may have a generally cylindrical shape. The chamber 222 may have a generally circular cross sectional shape, or it may have a geometrically determined shape to enhance the focusing of acoustic energy therein in the interior of the chamber 222. In an example the chamber 222 has a hexagonal cross section. In another example the chamber 222 has a capacity between one and one hundred gallons. In yet one example, the chamber 222 has a capacity between 5 and 20 gallons, for example being approximately 10 gallons.

Various sensors and control elements 250 may be included in system 200. For example, a temperature sensor that measures a temperature of the fluid contents of the system at one or more locations can be used. A pressure gauge or sensor can also be employed at one or more locations in the fluid circuit. A pressure control rupture disc may also be placed at one or more locations of the system to prevent unwanted pressure increases therein.

A control circuit 240 can be employed as part of system 200 in some embodiments. The control circuit 240 may be microprocessor based. This control circuit 240 may comprise electronic circuitry and machine readable instructions suitable for controlling one or more aspects of operation of the system 200. In some embodiments the temperature, pressure, flow rate, or other system parameters can be controlled by control circuit 240. Control circuit 240 may execute a software program that controls a speed or discharge pressure of pump 230. Various other fluid circuit elements, such as isolation valves between each of the respective components and inlet/outlet shutoffs on tank 222 may be installed as suitable for a given application and as appreciated by those skilled in the art upon consideration of the present description.

A user interface of circuitry 240 allows an operator (human or machine) to control certain process parameters of the system 200 and to monitor the process in general. Duty cycles of the ultrasonic transducer elements and pumping and pressure control and temperature control elements can be monitored and controlled by such circuit 240, whether locally operated or remotely operated through an optional interface or networking apparatus.

An outlet port 216 may be provided in chamber 222 for the contents to exit therefrom or for drainage of the same. The acoustically treated (e.g., cavitated) fluid 201 is introduced to another stage of system 200 as desired. For example, fluid 201 exiting the acoustic stage 210 of system 200 may be introduced to a gas control stage 220 of system 200. The gas control stage 220 may incorporate an aerator, ejector, venture device, or oxygenation gas control apparatus 225. The gas control apparatus 225 may include stages 222, 224, 226 that have varying cross sectional areas and act according to the laws of fluid mechanics to alter the velocity and pressure of a fluid flowing therethrough. This can be utilized to favorably affect a gas concentration within the flowing liquid in the gas control apparatus 225.

In some embodiments, the gas control apparatus can be used to favorably alter an oxygen content within the flowing beverage fluid resulting in an improved product 203 exiting the gas control stage 220. As an example, the gas control apparatus 225 may comprise a venture type hydrodynamic cavitation apparatus that causes hydrodynamic cavitation within the fluid flowing therethrough. Such cavitation further combines and activates the flowing fluid and the gas introduced therein.

The actions of the present system and method can cause conversion of ethanol or alcohol content to ketone, ester, acetone and/or acetic acid. The present process may further or alternately introduce hydrogen radicals or ions that react to make ester in the product. Oxidation and reduction reactions can also be achieved or enhanced, as well as hydrolysis processes as desired. In some aspects, the alcohol to ester ratio may be controlled by the present process.

It should be understood that the order of placement of the components described above can be implemented as shown in the illustrative examples, or the ordering and arrangement of the components and stages may be modified in some embodiments. Specifically, the gas control stage 220 and the acoustic treatment stage 210 of the process and system 200 may be interchanged if desired. In addition, the stages, shown as sequentially or serially applied, can also be applied in parallel. Furthermore, a plurality of such stages may be used in parallel and/or series to achieve a larger scale system having substantially the same effect described herein, but having greater volumetric throughput.

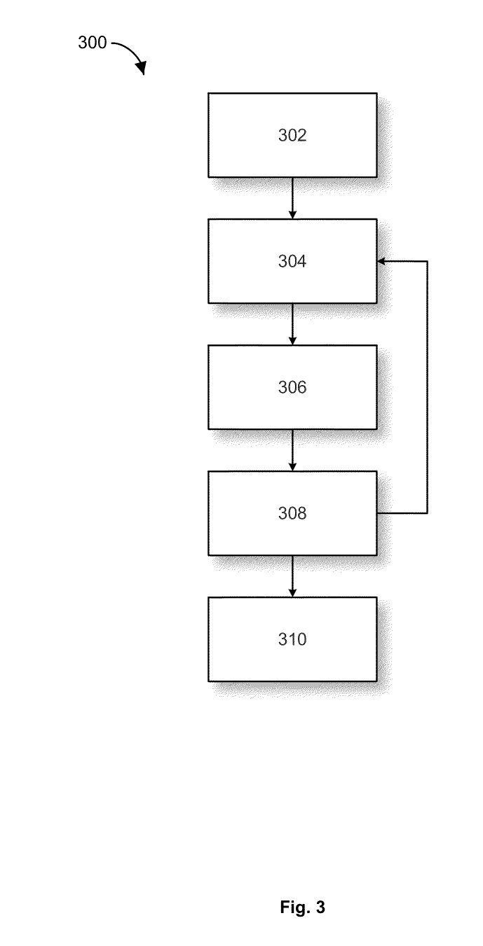

FIG. 3 illustrates a sequence of steps in a method 300 for treating a beverage such as a distilled beverage product. The steps include introducing an untreated beverage product to a system for treating the product at step 302. This step can include pumping or pouring or gravity draining the untreated liquid into a treatment apparatus or system. Then, at step 304, a first stage of treatment is applied, such as an acoustic treatment stage, and more specifically this step can include sonicating the fluid product using ultrasonic energy. Still more specifically, this can include causing acoustic cavitation in at least one portion of the liquid being treated.

At step 306 another treatment stage may be applied, such as a thermal (heating, cooling), pressurizing, depressurizing or other process. Also, a chemical processing step may be applied. It is noted again that the ordering of the steps may be manipulated to suit the application at hand, and that other intermediate steps may be performed, or some steps described herein may be omitted as necessary to achieve the desired effect.

A gas content control step 308 may be applied to the fluid beverage product being treated. This can comprise passing the fluid through a gas control apparatus such as the oxygenator or aerator or ejector devices mentioned earlier. A gaseous substance (e.g., air, oxygen) may be introduced or removed from the liquid as desired.

The method 300 can involve multiple iterations of the above stages of processing as necessary (re-circulate back to step 304 or repeat steps 304 through 308 in series or parallel) to provide the final treated beverage product at step 310. As mentioned earlier, the process may be monitored so that the correct or desired amount of treatment occurs, not more and not less.

The entire method 300 may be process controlled or computer controlled or automated to treat beverages in batch form or in continuous circulation form. In batch form the untreated beverage is introduced into the treatment system and remove when done. In continuous circulation form a flowing amount (at a determined or controlled rate, e.g., gallons per minute) of product is injected into the system, processed, and allowed to exit the system.

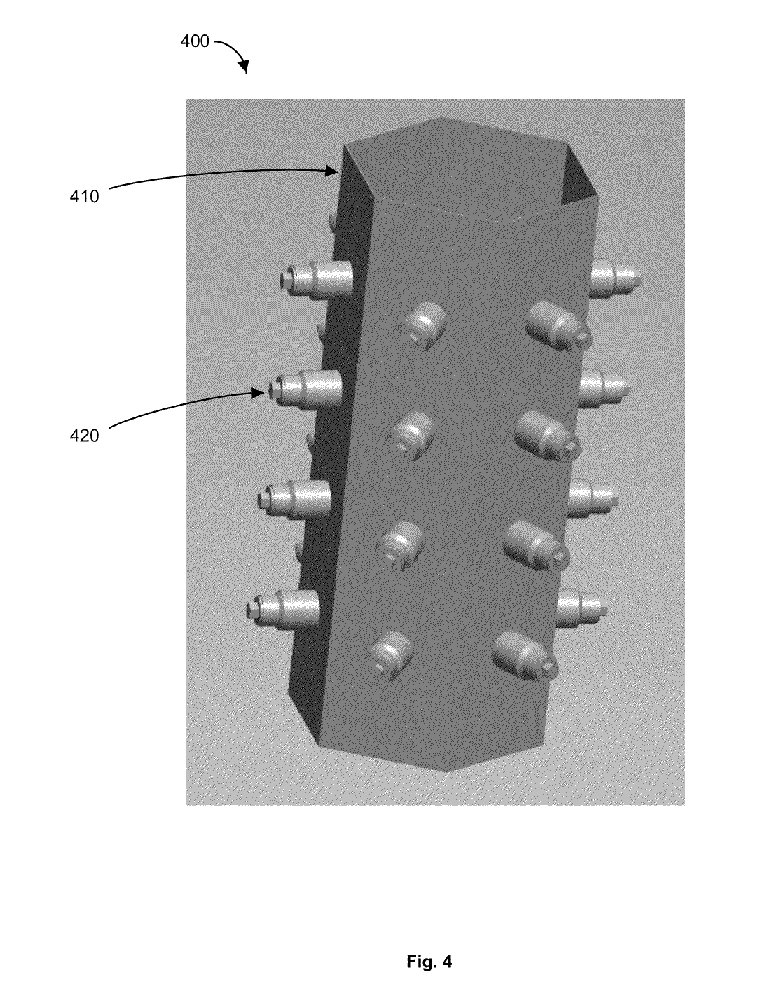

FIG. 4 illustrates an acoustic processing chamber 400 having multi-sided walls 410, e.g. having a hexagonal or similar cross section. A plurality of acoustic drivers or transducers 420 are attached to the walls 410 of chamber 400. The resulting acoustic field within the chamber 400 is suitable for generating acoustic cavitation bubbles to promote the reactions needed to transform an untreated beverage product according to the acoustic cavitation stages above.

Those skilled in the art of beverage distillation, fluid processing, food chemistry and related arts will appreciate the present disclosure and would understand that numerous variations on the examples provided herein are possible but covered within the present scope. The appended claims are intended to include in scope all such similar, derivative or equivalent permutations.

What is claimed is:

1. A system for processing an alcoholic beverage product, comprising:
a fluid handling circuit that allows movement of said product through said system;
an acoustic treatment chamber comprising a fluid holding chamber that holds said product while it undergoes acoustic processing;
at least one acoustic driver coupled to said acoustic treatment chamber that delivers acoustic energy to said acoustic treatment chamber and said product; and
a gas control device that controls an amount of gas in said product.

2. The system of claim 1, said at least one acoustic driver designed and configured to deliver an ultrasonic output sufficient to cause acoustic cavitation with a liquid product within said acoustic treatment chamber.

3. The system of claim 1, said fluid handling circuit comprising a fluid pressure source capable of pressurizing a fluid product in at least one portion of said system.

4. The system of claim 1, said acoustic treatment chamber comprising metal walls able to withstand an absolute static internal pressure inside said metal walls of at least twice the ambient static pressure outside the metal walls.

5. The system of claim 1, said gas control device comprising a venture tube.

6. The system of claim 1, said gas control device comprising a hydrodynamic cavitation device.

7. The system of claim 1, said gas control device comprising an aerator.

8. The system of claim 1, said gas control device comprising an ejector.

9. The system of claim 1, further comprising a control circuit that executes machine readable instructions and that controls the operation of at least one other component of the system.

10. The system of claim 1, said acoustic treatment chamber comprising a geometrically shaped volume having a plurality of sides so as to offer a geometrical concentration of acoustic energy in at least one region within said chamber.

11. A method for treating an alcoholic beverage product, comprising:
introducing a liquid alcoholic beverage product into a processing apparatus;
applying acoustic energy to said liquid product in an acoustic treatment chamber including causing acoustic cavitation therein;
passing said liquid product through a gas control apparatus; and
controlling an extent of said steps above until said liquid product reaches a desired processing level.

12. The method of claim 11, said step of passing the liquid product through said gas control apparatus comprising passing said liquid product through a hydrodynamic cavitation apparatus.

13. The method of claim 11, further comprising sensing at least one operational characteristic of said liquid product and controlling said steps of applying acoustic energy and passing said liquid product through the gas control apparatus based on said sensing of said characteristic.

14. The method of claim 11, further comprising controlling a temperature of said liquid product.

15. The method of claim 11, further comprising controlling a pressure of said liquid product.

16. The method of claim 15, further comprising pressurizing said liquid product within said acoustic treatment chamber to a pressure greater than ambient atmospheric pressure and simultaneously causing acoustic cavitation therein.

17. The method of claim 11, further comprising treating said liquid product in a chemical reaction process.
